(19) United States
(12) Patent Application Publication
(10) Pub. No.: US 2012/0211026 A1
(43) Pub. Date: Aug. 23, 2012

(54) Apparatus and Methods for Cleaning Reagent Dispensing Tips of a Screening Unit

(76) Inventor: Richard Jerome Schoeneck, Alexandria, MN (US)

(21) Appl. No.: 13/504,537

(22) PCT Filed: Oct. 29, 2010
(86) PCT No.: PCT/US10/54628

§ 371 Date: Apr. 27, 2012

Related U.S. Application Data
(60) Provisional application No. 61/256,470, filed on Oct. 30, 2009.

(51) Int. Cl. B08B 3/08

(52) U.S. Cl. 134/10; 134/21; 134/95.2

(57) ABSTRACT

A plurality of reagent dispensing tips (15) are inserted through frustoconical openings (28) in a cover (16) of a cleaning chamber in the form of intersecting axial bores (14) and sprayed with wash fluid from spray passages (34) in the peripheral wall (20) of the cover (16). Wash fluid from the spray passages (34) and flowing through the reagent dispensing tips (15), if hollow, can be drained from the cleaning chamber through a drain port (42). Air is drawn through the frustoconical openings (28) around the reagent dispensing tips (15) into the cleaning chamber, through filter element (64) and from a waste chamber (50) by a vacuum source (78) to remove wash fluid from and otherwise dry the reagent dispensing tips (15).

### BACKGROUND

The present invention generally relates to methods and apparatus for cleaning reagent dispensing tips of a screening unit and particularly to methods and apparatus for washing and drying reagent dispensing tips of a high throughput screening unit.

The goal of high throughput screening is to perform many tests reliably, quickly and inexpensively. Reliability is linked to the ability to control process parameters and avoid contamination. To avoid contamination, quality washing is of primary concern. However, the more time spent washing removes more contamination but at the expense of throughput. Furthermore, dilution is a problem. If wash fluid remains on the reagent dispensing tips, dilution of the reagent occurs in the next screening.

A conventional manner of washing reagent dispensing tips basically consists of dipping the reagent dispensing tips into a tub of wash fluid. Additionally, before, during or after the dipping process, wash fluid is passed through hollow reagent dispensing tips themselves into the tub of wash fluid. It should be appreciated that after each washing process, the wash fluid collects minute amounts of material from the exterior and interior of the reagent dispensing tips, such that contamination is a concern after the first time the wash fluid is utilized to wash reagent dispensing tips. To minimize this concern, the wash fluid is changed in the tub at frequent intervals. Although the theory is that wash fluid will detach from the reagent dispensing tips during normal movement of the reagent dispensing tips from the tub of wash fluid back to its screening location, wash fluid does remain on the reagent dispensing tips in reality such that dilution of the reagents does occur.

Thus, a need exists for methods and apparatus for cleaning reagent dispensing tips of a high throughput screening unit which overcome the problems of contamination and dilution of conventional washing of reagent dispensing tips, as well as taking less time and less wash fluid to allow high throughput screening reliably, quickly and inexpensively.

### SUMMARY

The present invention solves this need and other problems in the field of cleaning reagent dispensing tips in screening units by providing, in preferred aspects, methods and apparatus for washing as well as preferably drying reagent dispensing tips which does not involve dipping the reagent dispensing tips into a tub of wash fluid.

According to the teachings of the present invention, wash fluid is sprayed on the reagent dispensing tips while inserted and, most preferably, reciprocated in a cleaning chamber to thereby wash by showering the reagent dispensing tips. In preferred forms, gas in the form of air is moved around the reagent dispensing tips such as by a vacuum source drawing air from around the reagent dispensing tips inserted through restricted, frustoconical openings into the cleaning chamber, through a filter element and from a waste chamber to remove wash fluid from and otherwise dry the reagent dispensing tips. In most preferred forms, the cleaning chamber is in the form of intersecting axial bores of a cylindrical configuration concentric to a plurality of reagent dispensing tips arranged in a spaced, parallel relation in an array and/or a plane to create a cyclonic or downward spiral path for the wash fluid. Drain ports are provided in the cleaning and waste chambers for draining wash fluid therefrom.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a high throughput screening unit including an apparatus for cleaning according to the preferred teachings of the present invention.

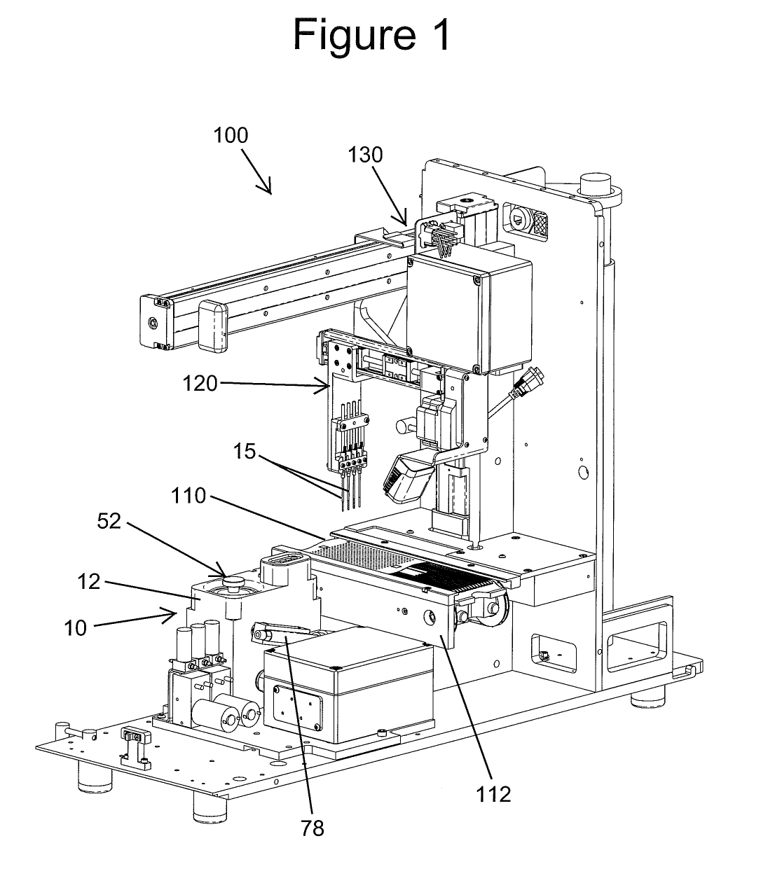

FIG. 2 shows a perspective view of the high throughput screening unit of FIG. 1 in a cleaning position.

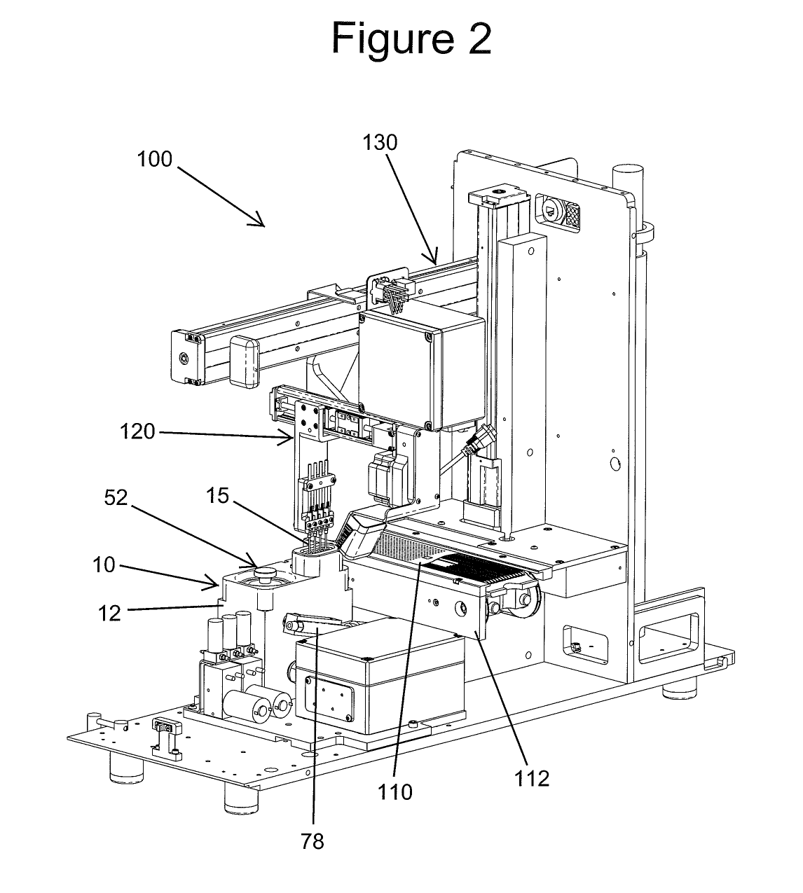

FIG. 3 shows a perspective view of reagent dispensing tips and the apparatus of FIG. 1.

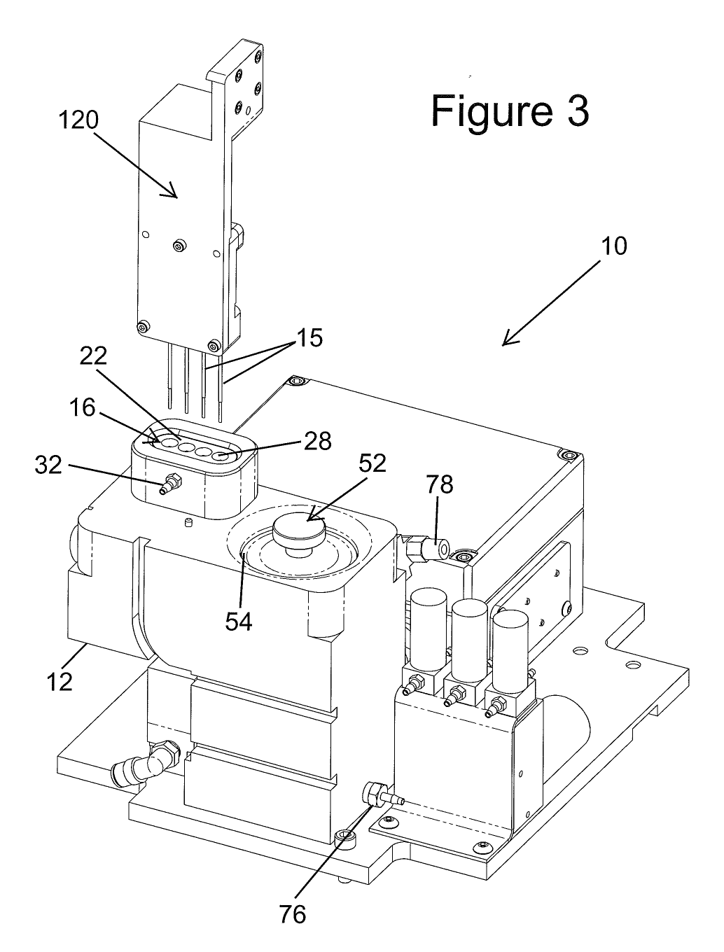

FIG. 4 shows a top plan view of the apparatus of FIG. 1.

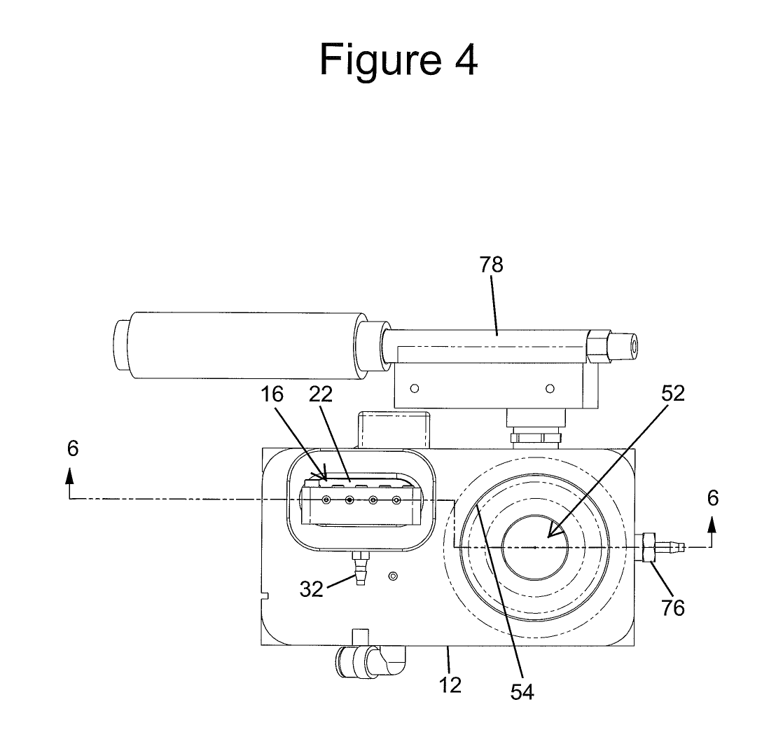

FIG. 5 shows an exploded perspective view of the apparatus of FIG. 1.

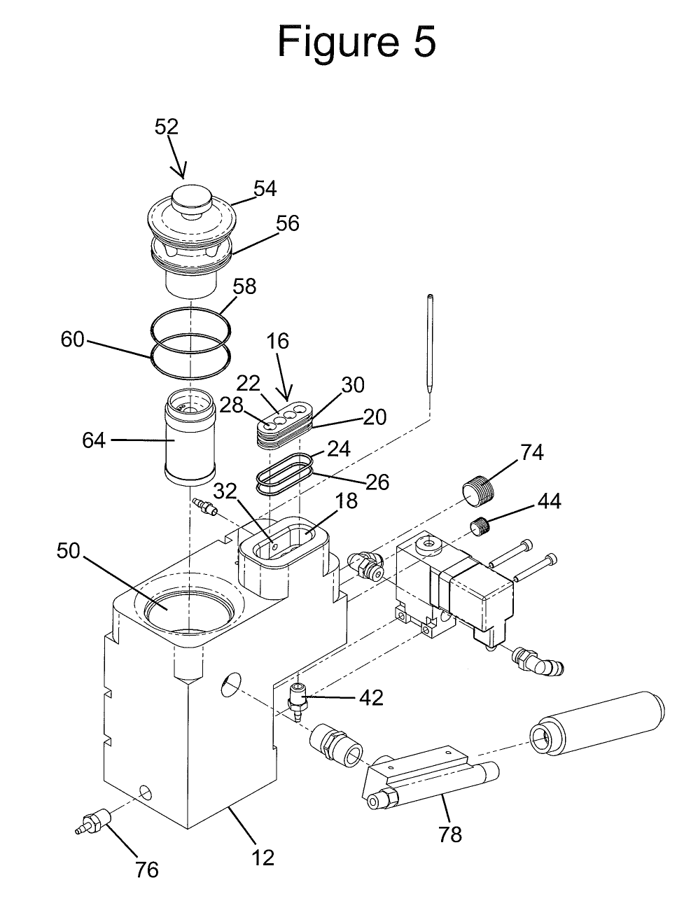

FIG. 6 shows a cross sectional view of the reagent dispensing tips and the apparatus of FIG. 1 according to section line 6-6 of FIG. 4.

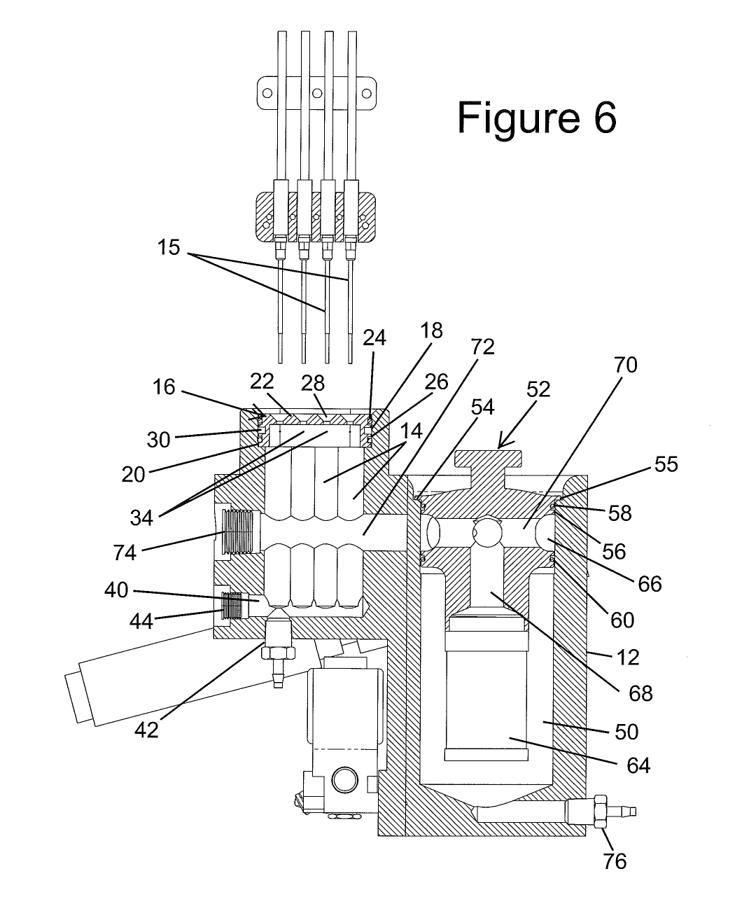

All figures are drawn for ease of explanation of the basic teachings of the present invention only; the extensions of the figures with respect to number, position, relationship, and dimensions of the parts to form the preferred embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “forward”, “rearward”, “reverse”, “front”, “back”, “height”, “width”, “length”, “end”, “side”, “horizontal”, “vertical”, and similar terms are used herein, it should be understood that these terms have reference only to the structure shown in the drawings as it would appear to a person viewing the drawings and are utilized only to facilitate describing the illustrative embodiments.

### DESCRIPTION OF THE PREFERRED EMBODIMENTS

Apparatus for cleaning reagent dispensing tips utilizing methods according to the teachings of the present invention is shown in the drawings and generally designated 10. Generally, apparatus 10 of the present invention is an element of a high throughput screening unit 100. Unit 100 generally includes suitable provisions for positioning a plurality of samples to which reagents are desired to be added. In the preferred form shown, samples are provided in a carrier tape 110 such as, but not limited to, the type shown in U.S. Pat. No. 6,878,345, which is hereby incorporated herein by reference, including a plurality of wells arranged in rows and columns forming an array. System 100 generally includes a suitable mechanism for moving and positioning carrier tape 110 along an X-direction such as a tractor drive 112 shown. It should be appreciated that samples according to the teachings of the present invention can be held and positioned in other manners including, but not limited to, currently conventional.

Screening unit 100 further includes a dispenser 120 for dispensing reagents into the positioned samples. In the preferred form shown, dispenser 120 includes a plurality of hollow reagent dispensing tips 15 of a conventional construction and arrangement. Particularly, in the preferred form shown, the plurality of reagent dispensing tips 15 are arranged in a plane in a spaced, parallel relation and/or in an array including at least one row and at least one column. As is conventional, reagent dispensing tips 15 can be supplied with desired reagents such as being inserted into a source of reagents which are drawn into reagent dispensing tips 15 such as by a vacuum system which is conventional and not shown. It should be appreciated that reagent dispensing tips 15 according to the teachings of the present invention can be of other forms and types than shown and including, but not limited to, the solid pin type and to which reagent adheres when dipped therein.

Unit 100 further includes suitable provisions 130 for moving reagent dispensing tips 15 relative to the samples in a Y-direction perpendicular to the X-direction and parallel to the top surface of carrier tape 110. In the most preferred form, provisions 130 also move reagent dispensing tips 15 in a Z-direction perpendicular to the X and Y directions and to the top surface of carrier tape 110. If desired, even though relative movement can be provided by tractor drive 112 in the preferred form shown, provisions 130 can also move reagent dispensing tips 15 in the X-direction parallel to the top surface of carrier tape 110. It should be appreciated that provisions 130 can be of a variety of types and forms including, but not limited to, as shown according to the teachings of the present invention and may be of a currently conventional design.

According to the teachings of the present invention, apparatus 10 is located in the Y-direction from the samples contained in carrier tape 110. Generally, apparatus 10 includes a housing 12 formed with intersecting axial bores 14 corresponding to and receiving reagent dispensing tips 15. A cover 16 is received in an enlarged counterbore 18 intersecting with each of bores 14, with counterbore 18 having race track shaped cross sections perpendicular to bores 14. Cover 16 includes a peripheral wall 20 corresponding to and for slideable receipt within counterbore 18 and includes a top 22 integrally connected to the upper edge of peripheral wall 20. The lower edge of peripheral wall 20 generally defines an open bottom for cover 16. Suitable first and second seals 24 and 26 are provided between cover 16 and counterbore 18 and intermediate the upper and lower edges of peripheral wall 20. As an example, seals 24 and 26 could be in the form of O-rings received on peripheral wall 20 and abutting with counterbore 18. Top 22 includes frustoconical shaped openings 28 extending therethrough for receipt of reagent dispensing tips 15 with relative close tolerance. It should be appreciated that axial bores 14 and cover 16 define a cleaning chamber in the preferred form shown which is believed to produce synergistic results. However, the cleaning chamber can be formed in different manners and of differing types according to the teachings of the present invention.

According to the teachings of the present invention, suitable provisions are provided to supply fluid under pressure into cover 16. In the preferred form shown, a channel 30 is formed in the peripheral wall 20 intermediate seals 24 and 26. A passage 32 extends through housing 12 corresponding to and in fluid communication with channel 30. Spray passages 34 extend between channel 30 and the inner surface of peripheral wall 20 and corresponding to reagent dispensing tips 15 and axial bores 14. In the most preferred form, two spray passages 34 are provided diametrically opposite of each reagent dispensing tip 15. It should be appreciated that passage 32 is in fluid communication with at least one source of wash fluid under pressure. As an example, wash fluid could be contained in a suitable container and supplied to passage 32 through suitable valves and a pump. In this regard, wash fluids of differing types and/or at different pressures or flow rates could be supplied to passage 32 at different times of operation according to the teachings of the present invention. Furthermore, although the provisions as shown and described are believed to produce synergistic results, it should be appreciated that wash fluid can be provided to axial bores 14 defining the cleaning chamber in other manners according to the teachings of the present invention.

Suitable provisions are provided to allow draining of fluids from axial bores 14. In the preferred form shown, a cross bore 40 extends from the exterior of housing 12 and interconnects with the lower ends of each of the axial bores 14. A drain port 42 extends through housing 12 and is in fluid communication with cross bore 40. Drain port 42 is in fluid communication with a suitable collection system. A plug 44 closes the end of cross bore 40 at the exterior of housing 12.

Housing 12 according to the preferred teachings of the present invention further includes a waste chamber 50 spaced from axial bores 14. A filter cap 52 is located in and supported in chamber 50. In the preferred form shown, filter cap 52 includes a circumferential flange 54 which rests upon a counterbore shoulder 55 formed in waste chamber 50. Filter cap 52 includes a peripheral surface 56 corresponding to and for slideable receipt within waste chamber 50. Suitable first and second seals 58 and 60 are provided between filter cap 52 and waste chamber 50. As an example, seals 58 and 60 could be in the form of O-rings received on peripheral surface 56 and abutting with waste chamber 50. A filter element 64 is mounted to filter cap 52 and is suspended from filter cap 52 within waste chamber 50. Suitable provisions are provided to provide fluid communication between axial bores 14 and waste chamber 50 through filter element 64. In particular, a channel 66 is formed in peripheral surface 56 intermediate seals 58 and 60. Filter cap 52 includes passage 68 in fluid communication with filter element 64 and which does not extend axially through filter cap 52. A plurality of interconnection passages 70 extend between channel 66 and passage 68 to provide fluid communication therewith. A cross bore 72 extends from the exterior of housing 12 and interconnects with each of axial bores 14 intermediate cross bore 40 and cover 16 and interconnects with waste chamber 50 generally at a location corresponding to channel 66. A plug 74 closes the end of cross bore 72 at the exterior of housing 12.

Suitable provisions are provided to allow removal of fluids from waste chamber 50. In the preferred form shown, a drain port 76 extends through housing 12 and is in fluid communication with waste chamber 50 below filter element 64 and with a suitable collection system. Additionally, a gas-pressure differential source shown in the most preferred form as a vacuum source 78 is in fluid communication with waste chamber 50 below seal 60 and above drain port 76.

Now that the basic construction of apparatus 10 according to the teachings of the present invention has been set forth, example methods of operation and some of the advantages obtained thereby can be explained and appreciated. For the sake of explanation, it will be assumed that reagent dispensing tips 15 have been suitably loaded with a reagent to be introduced to samples located in wells of carrier tape 110. Provisions 130 could move reagent dispensing tips 15 to be positioned corresponding to the desired samples, and the reagents are introduced into the sample. After introduction and assuming reagent dispensing tips 15 are desired to be cleaned, reagent dispensing tips 15 are moved by provisions 130 to be above and aligned with openings 28. Then, reagent dispensing tips 15 are moved relative to apparatus 10 such that tips 15 are inserted or enter axial bores 14 defining the cleaning chamber through openings 28 of cover 16. Upon entry of reagent dispensing tips 15 into openings 28, wash fluid is injected from spray passages 34 by the introduction of wash fluid through passage 32 and into channel 30. It should be appreciated that as reagent dispensing tips 15 pass further into axial bores 14, wash fluid from spray passages 34 will engage reagent dispensing tips 15 along their axial lengths. In preferred forms, reagent dispensing tips 15 are reciprocated in axial bores 14 multiple times in a direction parallel to reagent dispensing tips 15 and relative to spray passages 34 generally from a position where the orifices of reagent dispensing tips 15 are generally aligned with spray passages 34 to the maximum insertion distance. In this regard, multiple spray passages 34 could be located along the axial length of reagent dispensing tips 15 which can inject wash fluid simultaneously or in any desired sequence while reagent dispensing tips 15 are stationary or reciprocate.

Due to the cylindrical configuration of axial bores 14 concentric to reagent dispensing tips 15, wash fluid tends to follow a downward spiral path from spray passages 34 to cross bore 40. This spiral path of wash fluid enhances the cleaning effect of reagent dispensing tips 15 according to the most preferred teachings of the present invention.

After reagent dispensing tips 15 extend through openings 28 and assuming reagent dispensing tips 15 are hollow and either before, after, and/or during introduction of wash fluid through spray passages 34, wash fluid of the same or different type can be pumped or otherwise forced to flow through reagent dispensing tips 15 and into axial bores 14. In this regard, wash fluid passing through reagent dispensing tips 15 of apparatus 10 of the present invention can be accomplished in a similar manner as conventionally, if desired.

It can be appreciated that without activation of vacuum source 78, wash fluid introduced through hollow reagent dispensing tips 15 and through spray passages 34 into axial bores 14 will fall under gravitational forces into cross bore 40 where it will be drained through drain port 42 from housing 12 according to the teachings of the present invention.

According to the preferred teachings of the present invention, after the desired amount of wash fluid has been introduced through reagent dispensing tips 15 and spray passages 34, drain port 42 is closed and vacuum source 78 is activated to create a pressure differential and to move a gas in the most preferred form of air from waste chamber 50. Thus, in the preferred form shown, air is moved through axial bores 14 by being drawn though filter element 64, passage 68, interconnection passages 70, channel 66, cross bore 72, axial bores 14, and openings 28 around reagent dispensing tips 15. This movement of air around reagent dispensing tips 15 tends to dry reagent dispensing tips 15. This function is enhanced due to the frustoconical shape and the restricted size of openings 28. It should be appreciated that any wash fluid in liquid, mist or aerosol form will be captured by filter element 64 and will fall under gravitational forces into the bottom of filter element 64. Wash fluid in liquid form will pass through the bottom of filter element 64 to the bottom of waste chamber 50 where it can be drained through drain port 76. In most preferred forms, drain port 76 is opened only when vacuum source 78 is not activated.

It should be appreciated that maintenance of filter element 64 such as by cleaning or replacement can be accomplished by pulling filter cap 52 with filter element 64 attached thereto from waste chamber 50 when vacuum source 78 is not activated.

Now that the basic teachings of the present invention have been explained, many extensions and variations will be obvious to one having ordinary skill in the art. For example, although air movement is caused by vacuum source 78 in the most preferred form drawing air through openings 28, other manners of air movement can be utilized including providing air flow through reagent dispensing tips 15, providing air flow openings into axial bores 14, providing pressurized air flow into axial bores 14 such as through spray passages 34 alone or in combination with vacuum source 78 or the like.

Although it is described that reagent dispensing tips 15 are moved relative to the spray passages 34 by movement of reagent dispensing tips 15, it should be appreciated that housing 12 can be moveably mounted instead of or in addition to the movement of reagent dispensing tips 15 according to the teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method comprising:
inserting a reagent dispensing tip into a cleaning chamber;
spraying wash fluid on the reagent dispensing tip while inserted in the cleaning chamber; and
moving a gas through the cleaning chamber after spraying wash fluid.

2. The method of claim 1 wherein inserting the reagent dispensing tip comprises inserting the reagent dispensing tip into a restricted opening into the cleaning chamber; and wherein moving the gas comprises supplying a vacuum to draw the gas through the restricted opening and around the reagent dispensing tip.

3. The method of claim 2 wherein supplying the vacuum comprises supplying the vacuum to a waste chamber in fluid communication with the cleaning chamber, with moving the gas including passing the gas through a filter element in the waste chamber.

4. The method of claim 1 wherein moving the gas comprises moving air through the cleaning chamber.

5. The method of claim 1 further comprising:
draining wash fluid from the cleaning chamber before moving the gas through the cleaning chamber.

6. The method of claim 1 wherein spraying wash fluid comprises spraying wash fluid through a spray passage into the cleaning chamber and moving the reagent dispensing tip in a direction parallel to the reagent dispensing tip and relative to the spray passage when spraying wash fluid through the spray passage.

7. The method of claim 1 wherein inserting the reagent dispensing tip comprises inserting a hollow reagent dispensing tip into the cleaning chamber; and wherein the method further comprises:
flowing wash fluid through the reagent dispensing tip while inserted in the cleaning chamber.

8. The method of claim 1 wherein spraying wash fluid comprises spraying wash fluid to follow a downward spiral path in the cleaning chamber having a cylindrical configuration concentric to the reagent dispensing tip.

9. The method of claim 1 wherein inserting the reagent dispensing tip comprises inserting a plurality of reagent dispensing tips arranged in a plane in a spaced, parallel relation into the cleaning chamber in a form of a plurality of intersecting axial bores.

10. The method of claim 9 wherein inserting the plurality of reagent dispensing tips comprises inserting the plurality of reagent dispensing tips arranged in an array including at least one row and at least one column.

11. Apparatus comprising, in combination: a cleaning chamber; a reagent dispensing tip moveable relative to the cleaning chamber, with the cleaning chamber including a spray passage spraying wash fluid on the reagent dispensing tip moving relative to the cleaning chamber; and a pressure differential source moving a gas through the cleaning chamber and around the reagent dispensing tip.

12. The apparatus of claim 11 with the reagent dispensing tip moveable relative to the cleaning chamber in a movement direction parallel to the reagent dispensing tip, with the spray passage being aligned with the movement direction.

13. The apparatus of claim 11 wherein the pressure differential source comprises a vacuum source in fluid communication with the cleaning chamber and wherein the apparatus further comprises, in combination: a waste chamber in fluid communication with the cleaning chamber; and a filter element received in the waste chamber, with the filter element being in fluid communication intermediate the cleaning chamber and the vacuum source.

14. (canceled)

15. The apparatus of claim 11 wherein wash fluid is dispensed through the reagent dispensing tip into the cleaning chamber.

16. The apparatus of claim 11 further comprising, in combination: a closeable drain plug in a bottom of the cleaning chamber.

17. The apparatus of claim 11 wherein the cleaning chamber is an axial bore having a cylindrical configuration concentric to the reagent dispensing tip.

18. The apparatus of claim 17 wherein the cleaning chamber includes a cover having a peripheral wall corresponding to and for slideable receipt into the axial bore and a top integrally connected to an upper edge of the peripheral wall, with the top including a restricted opening for receipt of the reagent dispensing tip, with the spray passage formed in the peripheral wall.

19. The apparatus of claim 18 further comprising, in combination: first and second seals on an outer surface of the peripheral wall and in sealing engagement with the axial bore; and a channel formed on the outer surface of the peripheral wall, with the spray passage in fluid communication with the channel, wherein the restricted opening is a frustoconical opening of decreasing size toward the spray passage.

20. (canceled)

21. The apparatus of claim 11 further comprising, in combination: a plurality of reagent dispensing tips arranged in a plane in a spaced, parallel relation with the reagent dispensing tip, with the cleaning chamber being in a form of plurality of intersecting axial bores.

22. The apparatus of claim 21 wherein the plurality of reagent dispensing tips are arranged in an array including at least one row and at least one column.
